(19) United States
(12) Patent Application Publication
(10) Pub. No.: US 2025/0335753 A1
(43) Pub. Date: Oct. 30, 2025

(54) NEURAL NETWORK DEVICE AND MEMBRANE POTENTIAL HOLDING METHOD

(71) Applicant: KABUSHIKI KAISHA TOSHIBA, Tokyo (JP)

(72) Inventors: Kumiko NOMURA, Shinagawa Tokyo (JP); Yoshifumi NISHI, Yokohama Kanagawa (JP); Koichi MIZUSHIMA, Kamakura Kanagawa (JP); Kazuki MINEGISHI, Kawasaki Kanagawa (JP)

(73) Assignee: KABUSHIKI KAISHA TOSHIBA, Tokyo (JP)

(21) Appl. No.: 19/062,454

(22) Filed: Feb. 25, 2025

(30) Foreign Application Priority Data
Apr. 30, 2024 (JP) 2024-073315

(51) Int. Cl. G06N 3/049; G06N 3/063

(52) U.S. Cl. CPC G06N 3/049; G06N 3/063

(57) ABSTRACT

A neural network device according to an embodiment includes a plurality of synapse circuits and a plurality of neuron circuits. A first neuron circuit includes a first terminal to which a synaptic current is supplied. The first neuron circuit includes a secondary battery element, a spike generation circuit, and a reset control circuit. The secondary battery element accumulates a charge according to the synaptic current supplied to the first terminal. The spike generation circuit generates a spike signal when the membrane potential generated from the secondary battery element is larger than a threshold potential being a predetermined potential. The reset control circuit releases the charge accumulated in the secondary battery element during a refractory period being a predetermined time after generation of the spike signal.

### CROSS-REFERENCE TO RELATED APPLICATIONS

This application is based upon and claims the benefit of priority from Japanese Patent Application No. 2024-073315, filed on Apr. 30, 2024; the entire contents of which are incorporated herein by reference.

### FIELD

Embodiments described herein relate generally to a neural network device and a membrane potential holding method.

### BACKGROUND

In recent years, with advances in computer hardware, typified by graphical processing units (GPU), artificial intelligence technology has been rapidly developing. For example, image recognition and classification techniques, typified by convolutional neural networks (CNN), have already been used in various scenes in the real world. Artificial intelligence technology that is widely used now is based on the mathematical model in which the behavior of a biological neural circuit network is simplified. Such artificial intelligence technology is therefore implemented using computers, such as GPUs.

However, the implementation of the artificial intelligence technology with GPUs requires a large amount of power. In particular, learning operation in which features are extracted from a large volume of data and stored comes with an enormous amount of computation. For this reason, such a learning operation requires a very large amount of power, and is considered to be difficult to execute in an edge device, for example.

On the other hand, although energy consumption of the human brain is as low as 20 W, the human brain constantly learns an enormous volume of data online. Therefore, a technique of performing information processing by relatively faithfully reproducing brain activity by electric circuits has been studied in various countries of the world.

In the brain's neural circuit network, information is transmitted from a neuron (nerve cell) to a neuron as a signal of a voltage spike. A coupler called a synapse couples a neuron to a neuron. A voltage spike generated by a certain neuron is input to a post-neuron as a subsequent stage via a synapse. At this time, the strength of the voltage spike input to the post-neuron is adjusted by a synaptic weight, which is the coupling strength of the synapse.

The synapse converts the voltage spike received from a pre-neuron at a preceding stage into a synaptic current according to the synaptic weight and gives the synaptic current to the post-neuron. When the synaptic weight is large, the synapse gives a large synaptic current to the post-neuron; when the synaptic weight is small, the synapse gives a small synaptic current to the post-neuron.

Neurons hold inner potentials called membrane potentials. When having received a synaptic current from a synapse, the neuron increases the membrane potential in accordance with a magnitude of the received synaptic current. In addition, when no synaptic current is applied, the neuron decreases the membrane potential over time. Accordingly, the neuron increases the membrane potential with continuous application of the synaptic current at short time intervals, and decreases the membrane potential with no application of the synaptic current for a long time. The neuron then generates a voltage spike when the membrane potential rises to reach a firing threshold. The generation of a voltage spike by a neuron is called firing.

In addition, upon firing, a neuron returns its membrane potential to an initial potential. After returning the membrane potential to the initial potential, the neuron maintains the membrane potential at the initial potential for a period of time called a refractory period. In short, even when synaptic currents are applied during the refractory period, neurons do not increase the membrane potential. The neuron then changes the membrane potential after the end of the refractory period.

Such information processing mimicking the information transmission principle of the brain's neural circuit network is called spiking neural networks. The spiking neural network performs no numerical computation and performs information processing by increasing/decreasing the membrane potential according to the voltage spikes, generating the voltage spikes, and transmitting the voltage spikes by synapses. Conventional artificial intelligence requires an enormous amount of computation in learning operation. In contrast, the spiking neural network does not perform numerical computation, and thus is considered to efficiently perform data processing. For such reasons, in recent years, studies of implementing a spiking neural network on a semiconductor chip have been actively conducted.

When the spiking neural network is implemented on a semiconductor chip, the neuron is implemented by an analog circuit using members such as a resistor, a capacitor, and a comparator. This circuit accumulates a charge corresponding to the received synaptic current in a capacitor, and uses a voltage generated by the charge accumulated in the capacitor as a membrane potential. An interval of operation times, namely, a neuron firing times in the brain is several microseconds, indicating that its processing speed is very low as compared with a digital arithmetic circuit represented by a central processing unit (CPU). Therefore, when the spiking neural network is implemented on a semiconductor chip, the neuron needs to be implemented by a circuit that fires at low frequency. In order to achieve such an operation by an analog circuit, it is necessary to increase the capacity of the capacitor and to increase the resistance value of a resistor for leaking charges from the capacitor. Specifically, the capacitor used in the neuron has a capacity of 10 pF or more. The resistor for leaking charges from the capacitor has a resistance value of 100 MΩ or more.

However, in the current Complementary Metal Oxide Semiconductor (CMOS) technology, there is a limit to the maximum capacitance of the capacitor and the maximum resistance value of the resistor due to issues of the integration area and the operation speed, having a problem of difficulty integrating the capacity and the resistance sufficient for implementing the spiking neural network. This leads to the necessity to increase the capacity of the capacitor and increase the resistance value of the resistor in order to allow the spiking neural network implemented on the semiconductor chip to perform an appropriate operation mimicking the brain operation.

### BRIEF DESCRIPTION OF THE DRAWINGS

FIG. 1 is a configuration diagram of a neural network device;

FIG. 2 is a configuration diagram of a reservoir computing apparatus;

FIG. 3 is a diagram illustrating a connection relationship around a neuron circuit;

FIG. 4 is a configuration diagram of a first neuron circuit;

FIG. 5 is a diagram illustrating a layer structure of a secondary battery element;

FIG. 6 is a configuration diagram of a first neuron circuit according to a second embodiment;

FIG. 7 is a diagram illustrating a layer structure of an electronic/ionic resistive element;

FIG. 8 is a configuration diagram of a first neuron circuit according to a third embodiment;

FIG. 9 is a configuration diagram of a first neuron circuit according to a fourth embodiment;

FIG. 10 is a configuration diagram of a first neuron circuit according to a fifth embodiment; and

FIG. 11 is a configuration diagram of a first neuron circuit according to a sixth embodiment.

### DETAILED DESCRIPTION

A neural network device according to an embodiment includes a plurality of synapse circuits and a plurality of neuron circuits. Each of the synapse circuits is assigned with a synaptic weight. Each of the neuron circuits is configured to generate a spike signal. Each of the synapse circuits is configured to acquire the spike signal from one of the neuron circuits, and output a synaptic current according to the synaptic weight in response to acquiring the spike signal. A first neuron circuit in the neuron circuits includes a first terminal. The first terminal is supplied with the synaptic current from each of one or more of the synapse circuits. The first neuron circuit includes a secondary battery element, a spike generation circuit, and a reset control circuit. The secondary battery element is configured to accumulate a charge according to the synaptic current supplied to the first terminal. The spike generation circuit is configured to generate the spike signal when a membrane potential generated from the secondary battery element is larger than a threshold potential being a predetermined potential. The reset control circuit is configured to release the charge accumulated in the secondary battery element during a refractory period being a predetermined time period after generation of the spike signal.

Hereinafter, a neural network device 10 according to an embodiment will be described with reference to the drawings.

### First Embodiment

The neural network device 10 according to a first embodiment is a spiking neural network configured by hardware components. For example, the neural network device 10 is implemented on a semiconductor device by a process such as CMOS.

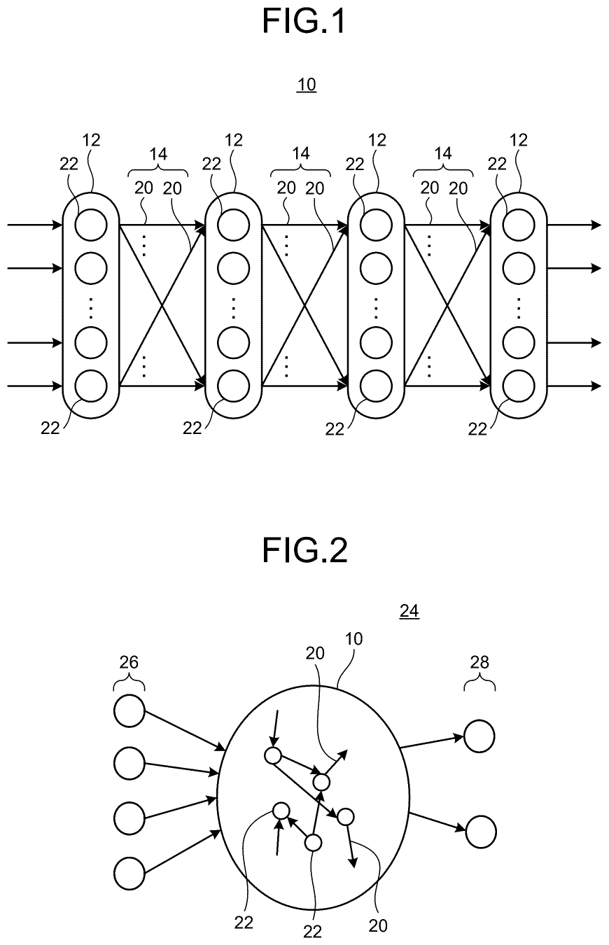

FIG. 1 is a diagram illustrating an example of a configuration of the neural network device 10. As an example, the neural network device 10 according to the first embodiment includes M (M is an integer of 2 or more) layers 12 and (M−1) synapse groups 14.

Each of the (M−1) synapse groups 14 includes a plurality of synapse circuits 20. A synaptic weight is assigned to each of the synapse circuits 20. The synaptic weights to be assigned to the synapse circuits 20 are set by learning processing. In one example, the synaptic weights assigned to the synapse circuits 20 may be updated by a predetermined update rule such as Spike Timing Dependent Plasticity (STDP) or Spike Driven Synaptic Plasticity (SDSP). Each of the M layers 12 includes a plurality of neuron circuits 22. Each of the neuron circuits 22 generates a spike signal that is a pulsed voltage signal.

An m-th (m is an integer of 1 or more and (M−1) or less) synapse group 14 among the (M−1) synapse groups 14 is disposed between an m-th layer 12 of the M layers 12 and an (m+1)-th layer 12 of the M layers 12.

Each of the synapse circuits 20 included in the m-th synapse group 14 acquires a spike signal output from any one neuron circuit 22 among the neuron circuits 22 included in the m-th layer 12. When the spike signal is acquired, each of the synapse circuits 20 included in the m-th synapse group 14 outputs a synaptic current according to the synaptic weight that has been assigned. The synaptic weight may be represented by a binary value or may be represented by a multivalued discrete value of three or more values. Alternatively, the synaptic weight may be represented by an analog value, namely, by an amount of charge accumulated in a capacitor or the like or a resistance value of a variable resistor.

Each of the synapse circuits 20 included in the m-th synapse group 14 applies a synaptic current to one of the neuron circuits 22 included in the (m+1)-th layer 12.

Each of the neuron circuits 22 included in the (m+1)-th layer 12 among the M layers 12 acquires synaptic currents output from the m-th synapse group 14, and executes processing corresponding to a product-sum operation on the acquired synaptic currents. Note that the first layer 12 of the M layers 12 acquires a plurality of signals from an external device or an input layer. Subsequently, each of the neuron circuits 22 outputs a spike signal obtained by performing processing corresponding to an activation function on the signal representing the operation result.

In such a neural network device 10, the first layer 12 receives one or more signals from an external device or an input layer. Subsequently, the neural network device 10 outputs, from the m-th layer 12, one or more signals indicating a result of the operation executed by the neural network on the one or more signals received.

Note that the neural network device 10 may separately include a control circuit. For example, based on the spike signal output from each of the neuron circuits 22, the control circuit controls a learning threshold used for the learning processing of the synaptic weight assigned to each of the synapse circuits 20. Moreover, the control circuit may control input/output of data related to the neural network device 10.

FIG. 2 is a diagram illustrating a configuration of a reservoir computing apparatus 24.

The neural network device 10 is not limited to the structure of transferring a signal in the forward direction as illustrated in FIG. 1, and may be a recurrent neural network of performing internal feedback of signals. In a case where the neural network device 10 is a recurrent neural network, for example, the neural network device 10 is applicable to the reservoir computing apparatus 24 as illustrated in FIG. 2.

The reservoir computing apparatus 24 includes: an input layer 26, a neural network device 10 being a recurrent neural network; and an output layer 28.

The input layer 26 acquires one or more signals from an external device. The input layer 26 outputs the acquired one or more signals to the neural network device 10. The output layer 28 acquires one or more spike signals from the neural network device 10. Subsequently, the output layer 28 outputs one or more signals to an external device.

Each of the neuron circuits 22 included in the neural network device 10 acquires synaptic currents from some synapse circuit 20 among the synapse circuits 20 included in the neural network device 10. In addition, some of the neuron circuits 22 among the neuron circuits 22 acquire signals from the input layer 26. In addition, some of the neuron circuits 22 among the neuron circuits 22 output a spike signal to the output layer 28.

Each of the synapse circuits 20 acquires the spike signal output from any one of the neuron circuits 22. Each of the synapse circuits 20 outputs a synaptic current to any one neuron circuit 22 among the neuron circuits 22.

Subsequently, at least one of the synapse circuits 20 performs feedback of a synaptic current and outputs the synaptic current to the own circuit or another neuron circuit 22. In other words, at least one of the synapse circuits 20 outputs a synaptic current to the own circuit, the neuron circuit 22 that has given a spike signal to the synapse circuit 20, or the neuron circuit 22 at a preceding stage of the neuron circuit 22 that has given the spike signal to the own circuit.

The reservoir computing apparatus 24 having such a configuration can function as a hardware device that performs reservoir computing.

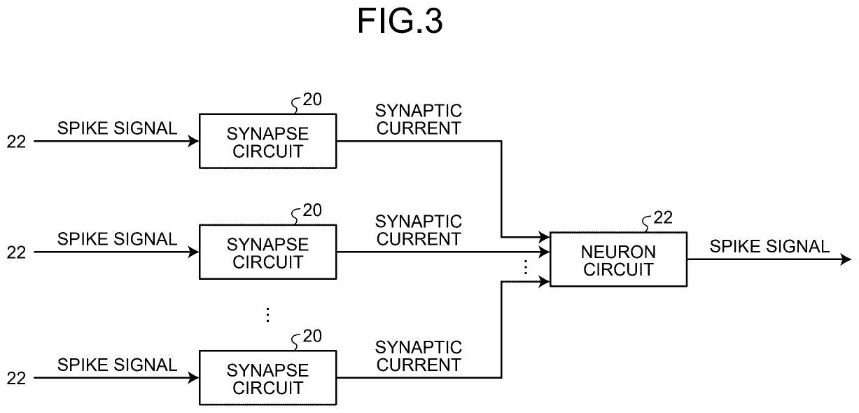

FIG. 3 is a diagram illustrating a connection relationship around the neuron circuit 22.

Each of the synapse circuits 20 acquires a spike signal from any one neuron circuit 22 among the neuron circuits 22. Each of the synapse circuits 20 includes a current generation circuit. When having acquired the spike signal, each of the synapse circuits 20 converts the spike signal acquired using the current generation circuit into a synaptic current according to the synaptic weight that has been assigned, and outputs the synaptic current to the neuron circuit 22 in the subsequent stage. Each of the synapse circuits 20 outputs a synaptic current such that, the larger the synaptic weight being assigned, the larger the amplitude of the synaptic current to be output. Alternatively, for example, each of the synapse circuits 20 may output the synaptic current such that, the larger the synaptic weight being assigned, the higher the occurrence frequency for outputting the synaptic current.

Each of the neuron circuits 22 holds an inner potential called a membrane potential Vₘₑₘ. When having acquired a synaptic current from any of the synapse circuits 20 connected as a preceding stage, the neuron circuit 22 increases the membrane potential Vₘₑₘ in accordance with the magnitude of the synaptic current acquired. In addition, when not having acquired the synaptic current, each of the neuron circuits 22 lowers the membrane potential Vₘₑₘ with the lapse of time. Therefore, each of the neuron circuits 22 increases the membrane potential Vₘₑₘ when having continuously acquired the synaptic current repeatedly at short time intervals, and decreases the membrane potential Vₘₑₘ when not having acquired the synaptic current for a long period of time. When the membrane potential Vₘₑₘ reaches a predetermined initial potential, each of the neuron circuits 22 stops lowering of the membrane potential Vₘₑₘ.

Subsequently, when the membrane potential Vₘₑₘ has increased to reaches the threshold potential Vₜₕ, each of the neuron circuits 22 fires and outputs a spike signal to the synapse circuit 20 as a subsequent stage.

In addition, when having fired, each of the neuron circuits 22 returns the membrane potential Vₘₑₘ to the initial potential. During a refractory period being a predetermined time after firing, each of the neuron circuits 22 does not increase the membrane potential Vₘₑₘ and stops further firing even when a synaptic current is applied. After the end of the refractory period, each of the neuron circuits 22 starts accumulation of charges according to the synaptic current. The initial potential is smaller than the threshold potential Vₜₕ. The initial potential and the threshold potential Vₜₕ are preset potentials.

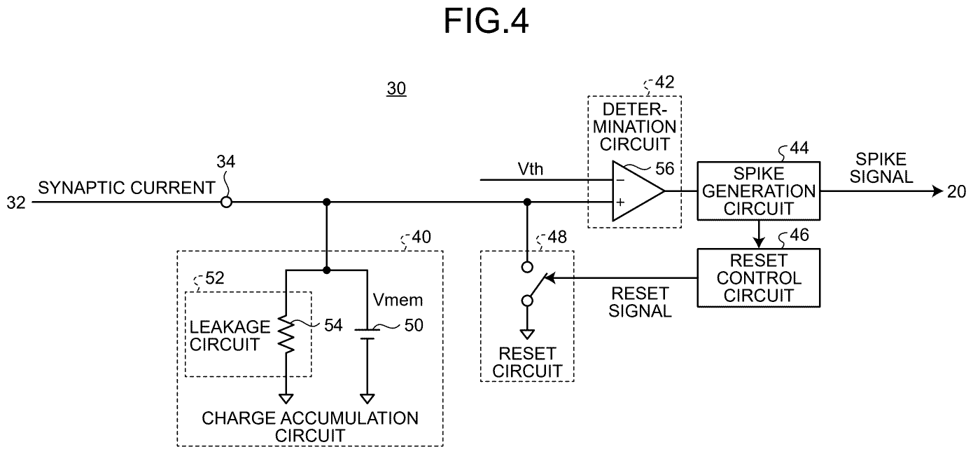

FIG. 4 is a diagram illustrating a configuration of a first neuron circuit 30, which is any one of the neuron circuits 22. All the neuron circuits 22 may have the same configuration as the first neuron circuit 30, or some of the neuron circuits 22 may have the same configuration as the first neuron circuit 30.

The first neuron circuit 30 is connected with one or more first synapse circuits 32 individually among the synapse circuits 20, as preceding stage circuits. The first neuron circuit 30 has a first terminal 34. In the first neuron circuit 30, a synaptic current is supplied to the first terminal 34 from each of one or more of the first synapse circuits 32 connected, as a preceding stage, to the first neuron circuit 30.

The first neuron circuit 30 includes a charge accumulation circuit 40, a determination circuit 42, a spike generation circuit 44, a reset control circuit 46, and a reset circuit 48.

The charge accumulation circuit 40 accumulates a charge according to the synaptic current supplied to the first terminal 34. The charge accumulation circuit 40 generates a membrane potential Vₘₑₘ at the first terminal 34 in accordance with the accumulated charges. Accordingly, the charge accumulation circuit 40 increases the membrane potential Vₘₑₘ generated at the first terminal 34 every time the synaptic current is supplied.

Moreover, the charge accumulation circuit 40 decreases the accumulated charge with the lapse of time. Therefore, in a case where the synaptic current is not supplied, the charge accumulation circuit 40 lowers the membrane potential Vₘₑₘ generated at the first terminal 34, according to the lapse of time.

In the present embodiment, the charge accumulation circuit 40 includes a secondary battery element 50 and a leakage circuit 52.

The secondary battery element 50 is a thin-film solid-state secondary battery implemented on a semiconductor device. The secondary battery element 50 generates a voltage corresponding to the accumulated charge. At the time of charging, the secondary battery element 50 accumulates a charge according to a given synaptic current. At the time of discharging, the secondary battery element 50 releases a charge according to a current to be released. The secondary battery element 50 is connected between the first terminal 34 and a ground terminal, and receives the synaptic current supplied to the first terminal 34.

The leakage circuit 52 is connected in parallel between two terminals of the secondary battery element 50. The leakage circuit 52 causes a leakage current to flow from the secondary battery element 50 to the ground terminal to leak the charge accumulated in the secondary battery element 50. In the present embodiment, the leakage circuit 52 includes a resistive element 54 implemented on a semiconductor device. The resistive element 54 is connected between the first terminal 34 and the ground terminal. The magnitude of the leakage current flowing from the leakage circuit 52 is determined by the resistance value of the resistive element 54 and the membrane potential Vₘₑₘ generated from the secondary battery element 50. The resistive element 54 has a relatively large resistance value of 100 MΩ or more, for example, and releases the charge accumulated in the secondary battery element 50 over a sufficiently long time. Alternatively, the resistive element 54 may be formed with a transistor. In this case, the leakage current value is determined by the gate voltage of the transistor.

The determination circuit 42 compares the membrane potential Vₘₑₘ generated from the secondary battery element 50 with a preset threshold potential Vₜₕ, and determines whether the membrane potential Vₘₑₘ is larger than the threshold potential Vₜₕ. An example of the determination circuit 42 is a comparator 56 implemented on a semiconductor device. In the comparator 56, a threshold potential Vₜₕ is applied to an inverting input terminal, while a non-inverting input terminal is connected to the first terminal 34. The determination circuit 42 outputs a determination signal that indicates logical HIGH (logical H) when having determined that the membrane potential Vₘₑₘ is larger than the threshold potential Vₜₕ and that indicates logical LOW (logical L) when having determined that the membrane potential Vₘₑₘ is not larger than the threshold potential Vₜₕ.

The spike generation circuit 44 acquires the determination signal from the determination circuit 42, and generates a spike signal being a pulsed voltage signal when the membrane potential Vₘₑₘ is determined to be larger than the threshold potential Vₜₕ. The spike generation circuit 44 gives the generated spike signal to the synapse circuit 20 connected subsequent to the first neuron circuit 30.

The reset control circuit 46 outputs a reset signal during a refractory period after the spike signal is output from the spike generation circuit 44. The refractory period is a predetermined time from the timing of the rear edge of the pulsed spike signal. For example, the reset control circuit 46 outputs a reset signal that indicates logical H during the refractory period and indicates logical L during a period other than the refractory period.

When the spike signal is generated, the reset circuit 48 releases the charge accumulated in the secondary battery element 50 and connects the first terminal 34 to the ground terminal during the refractory period. In the present embodiment, when the reset signal at logical L is output from the reset control circuit 46, the reset circuit 48 disconnects between the first terminal 34 and the ground terminal, and short-circuits between the first terminal 34 and the ground terminal during a period in which the reset signal at logical H is output from the reset control circuit 46. The reset circuit 48 may be implemented by a device such as a metal-oxide-semiconductor field-effect transistor (MOSFET), which is turned on or off by a reset signal, for example.

When the spike signal is generated, such a reset circuit 48 can release the charge accumulated in the secondary battery element 50 to the ground terminal and return the membrane potential Vₘₑₘ generated from the secondary battery element 50 to the initial potential. In addition, the reset circuit 48 can allow the synaptic current supplied during the refractory period to flow to the ground terminal so as to suppress accumulation of charges in the secondary battery element 50. Moreover, during the refractory period, the reset circuit 48 can supply the potential of the ground terminal to the determination circuit 42 instead of the membrane potential Vₘₑₘ generated from the secondary battery element 50 so as to suppress generation of the spike signal from the spike generation circuit 44. After the end of the refractory period, the reset circuit 48 can stop the charge release from the secondary battery element 50 and can enable accumulation of the charge according to the synaptic current supplied to the first terminal 34 in the secondary battery element 50.

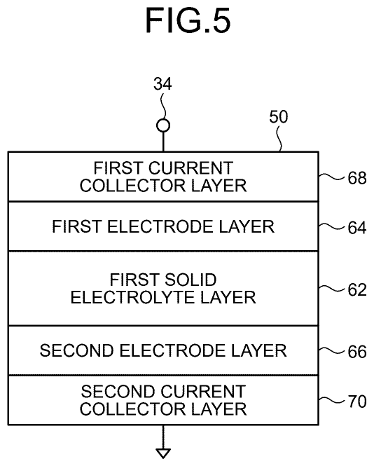

FIG. 5 is a diagram illustrating a layer structure of the secondary battery element 50.

The secondary battery element 50 includes a first solid electrolyte layer 62, a first electrode layer 64, a second electrode layer 66, a first current collector layer 68, and a second current collector layer 70. The secondary battery element 50 has a layer structure including the first current collector layer 68, the first electrode layer 64, the first solid electrolyte layer 62, the second electrode layer 66, and a second current collector layer 70 in this order.

The first solid electrolyte layer 62 is formed with a solid electrolyte having ion permeability and having less electron permeability. In other words, the first solid electrolyte layer 62 is a solid substance having substantially no electron permeability as compared with ion permeability. In the present embodiment, the first solid electrolyte layer 62 is a lithium ion conductor that has permeability to lithium ions. The first solid electrolyte layer 62 may be a solid substance that has permeability to other ions, for example, sodium ions or silver ions, instead of lithium ions.

The first solid electrolyte layer 62 can be formed with, for example, the following substances.

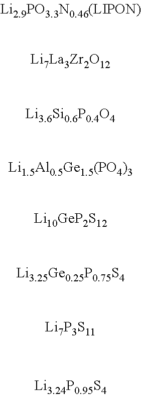

The first electrode layer 64 and the second electrode layer 66 are provided to face each other across the first solid electrolyte layer 62. More specifically, the first electrode layer 64 and the second electrode layer 66 are provided so as to face each other in an ion passage direction in the first solid electrolyte layer 62. The first electrode layer 64 and the second electrode layer 66 each are a solid substance capable of containing ions passed through the first solid electrolyte layer 62 in a lattice gap or a lattice position. In the present embodiment, the first electrode layer 64 and the second electrode layer 66 each are a metal compound capable of containing lithium ions in a lattice gap or a lattice position.

The first electrode layer 64 and the second electrode layer 66 have a layered structure, for example. The first electrode layer 64 and the second electrode layer 66 can be formed with, for example, the following substances capable of containing lithium ions in the lattice gap.

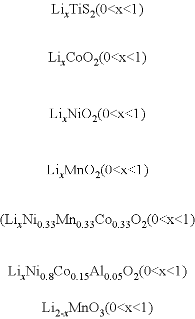

In addition, the first electrode layer 64 and the second electrode layer 66 can be formed with the following substances, including spinel, for example, capable of containing lithium ions at lattice positions.

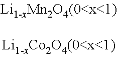

In addition, the first electrode layer 64 and the second electrode layer 66 can be formed with the following substances, including olivine, for example, capable of containing lithium ions at lattice positions.

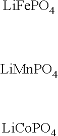

In addition, the first electrode layer 64 and the second electrode layer 66 can be formed with the following substances, including tavorite, for example, capable of containing lithium ions at lattice positions.

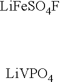

In addition, the first electrode layer 64 and the second electrode layer 66 can be formed with the following substances, including a rock salt spinel mixture, for example, capable of containing lithium ions at lattice positions.

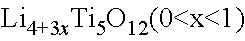

Incidentally, the change in the lattice constant due to the inflow and outflow of lithium ions is smaller in a substance capable of containing lithium ions at the lattice position than in a substance capable of containing lithium ions in the lattice gap. In particular, in the case of Li₄₊₃ₓTi₅O₁₂ (0<x<1), the lattice constant changes only several percent between the state of x=1 and the state of x=0. In this manner, the substance containing lithium ions at the lattice positions has a smaller change in the lattice constant due to inflow and outflow of lithium ions than the substance containing lithium ions in the lattice gap, and thus is preferable from the viewpoint of the capability to suppress defects such as deterioration of the element caused by the change in the lattice constant due to inflow and outflow of lithium ions.

The first current collector layer 68 is connected to the first electrode layer 64 and is formed with metal. The first current collector layer 68 is formed on a surface of the first electrode layer 64 opposite to the first solid electrolyte layer 62. The first current collector layer 68 is connected to the first terminal 34.

The second current collector layer 70 is connected to the second electrode layer 66 and is formed with metal. The second current collector layer 70 is formed on a surface of the second electrode layer 66 opposite to the first solid electrolyte layer 62. The second current collector layer 70 is connected to the ground terminal.

The first current collector layer 68 and the second current collector layer 70 are each formed with a material such as Au, Pt, Cu, or Ti, for example. The following will describe a case where the first electrode layer 64 is a positive electrode and the second electrode layer 66 is a negative electrode.

In such a secondary battery element 50, a charge moves individually in the first electrode layer 64 and the second electrode layer 66 when a synaptic current is supplied to the first terminal 34. When a synaptic current is supplied to the first terminal 34, ions contained in the first electrode layer 64 move to the second electrode layer 66 via the first solid electrolyte layer 62. As a result, the secondary battery element 50 increases charges to accumulate, leading to an increase in the membrane potential V mem. However, when the ions contained in the first electrode layer 64 are 0, there is no movement of ions when a synaptic current is supplied to the first terminal 34, and thus the secondary battery element 50 does not increase the membrane potential V mem.

In addition, when no synaptic current is supplied to the first terminal 34 and when the first current collector layer 68 and the second current collector layer 70 are connected due to short circuit or via a resistor, the first electrode layer 64 and the second electrode layer 66 each have internal ion movement in the opposite direction to the case where the synaptic current is supplied to the first terminal 34. When no synaptic current is supplied to the first terminal 34 and the first current collector layer 68 and the second current collector layer 70 are connected to each other due to short circuit or via a resistor, the ions contained in the second electrode layer 66 move to the first electrode layer 64 via the first solid electrolyte layer 62. As a result, the secondary battery element 50 decreases charges to accumulate, leading to a decrease in the membrane potential Vₘₑₘ.

The secondary battery element 50 like this can achieve a large effective capacity sufficient for use in a spiking neural network with a small integration area as compared with a capacitor formed in a semiconductor device. Accordingly, the neural network device 10 according to the present embodiment can include a plurality, being a sufficient number, of neuron circuits 22 to constitute the spiking neural network while sufficiently increasing the amount of charges to accumulate. Consequently, with the neural network device 10 according to the present embodiment, it is possible to perform an operation appropriately mimicking the operation of the brain.

### Second Embodiment

Hereinafter, a neural network device 10 according to a second embodiment will be described. Since the neural network device 10 according to the second embodiment has substantially the same function and configuration as those of the first embodiment, components having substantially the same function and configuration as those of the first embodiment are denoted by the same reference numerals, and description thereof is omitted except for their differences. The similar applies to the third embodiment and subsequent embodiments.

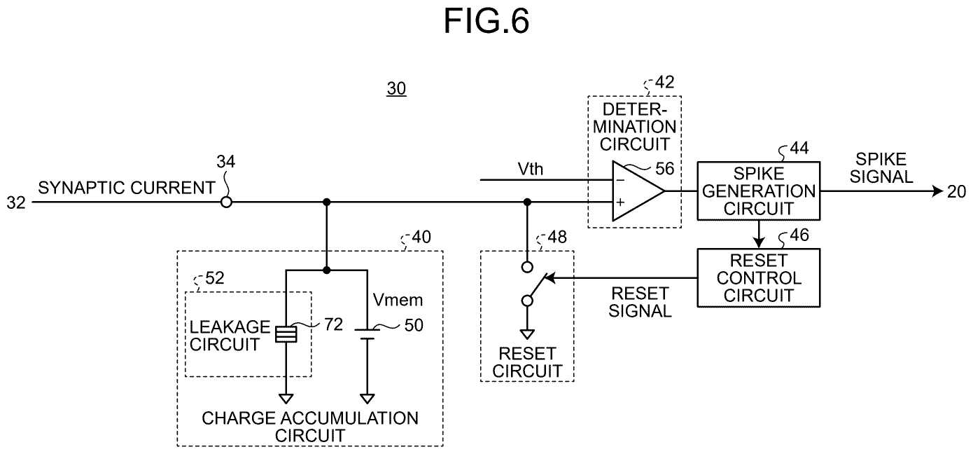

FIG. 6 is a diagram illustrating a configuration of a first neuron circuit 30 according to the second embodiment.

A leakage circuit 52 according to the second embodiment includes an electronic/ionic resistive element 72 instead of the resistive element 54. The electronic/ionic resistive element 72 has a layer structure similar to that of the secondary battery element 50, but does not generate electromotive force. In addition, when the electronic/ionic resistive element 72 is connected in parallel to the secondary battery element 50, the resistance value is adjusted to deliver a desired current. The leakage circuit 52 according to the second embodiment may include the resistive element 54 and the electronic/ionic resistive element 72.

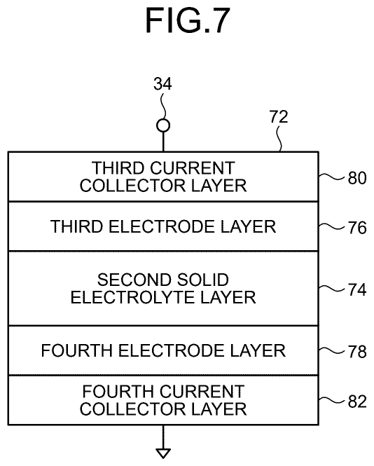

FIG. 7 is a diagram illustrating a layer structure of the electronic/ionic resistive element 72.

The electronic/ionic resistive element 72 includes a second solid electrolyte layer 74, a third electrode layer 76, a fourth electrode layer 78, a third current collector layer 80, and a fourth current collector layer 82. The electronic/ionic resistive element 72 has a layer structure including the third current collector layer 80, the third electrode layer 76, the second solid electrolyte layer 74, the fourth electrode layer 78, and the fourth current collector layer 82 in this order.

The second solid electrolyte layer 74 is formed with a solid electrolyte having ion permeability and less electron permeability. The second solid electrolyte layer 74 has a configuration similar to the first solid electrolyte layer 62 of the secondary battery element 50.

The third electrode layer 76 and the fourth electrode layer 78 are provided to face each other across the second solid electrolyte layer 74. More specifically, the third electrode layer 76 and the fourth electrode layer 78 are provided so as to face each other in the ion passage direction in the second solid electrolyte layer 74. The third electrode layer 76 and the fourth electrode layer 78 each are a solid substance capable of containing ions passed through the second solid electrolyte layer 74 in a lattice gap or a lattice position. The third electrode layer 76 has a configuration similar to the first electrode layer 64 of the secondary battery element 50. The fourth electrode layer 78 has a configuration similar to the second electrode layer 66 of the secondary battery element 50.

Note that the third electrode layer 76 and the fourth electrode layer 78 are formed with an identical substance so as not to generate electromotive force. For example, the third electrode layer 76 and the fourth electrode layer 78 are formed with Li₄₊₃ₓTi₅O₁₂ (0<x<1), which is a rock salt spinel mixture.

The third current collector layer 80 is connected to the third electrode layer 76 and is formed with metal. The third current collector layer 80 is formed on a surface of the third electrode layer 76 opposite to the second solid electrolyte layer 74. The third current collector layer 80 is connected to the first terminal 34.

The fourth current collector layer 82 is connected to the fourth electrode layer 78 and is formed with metal. The fourth current collector layer 82 is formed on a surface of the fourth electrode layer 78 opposite to the second solid electrolyte layer 74. The fourth current collector layer 82 is connected to the ground terminal.

The third current collector layer 80 and the fourth current collector layer 82 are each formed with a material such as Au, Pt, Cu, or Ti, for example.

Such an electronic/ionic resistive element 72 can achieve a large resistance value sufficient for use in a spiking neural network with a smaller integration area compared with the resistor formed in the semiconductor device. Accordingly, the neural network device 10 according to the present embodiment can include a plurality, being a sufficient number, of neuron circuits 22 to constitute the spiking neural network while sufficiently decreasing the amount of leakage current delivered by each circuit. Consequently, with the neural network device 10 according to the present embodiment, it is possible to perform an operation appropriately mimicking the operation of the brain.

### Third Embodiment

Hereinafter, a neural network device 10 according to a third embodiment will be described.

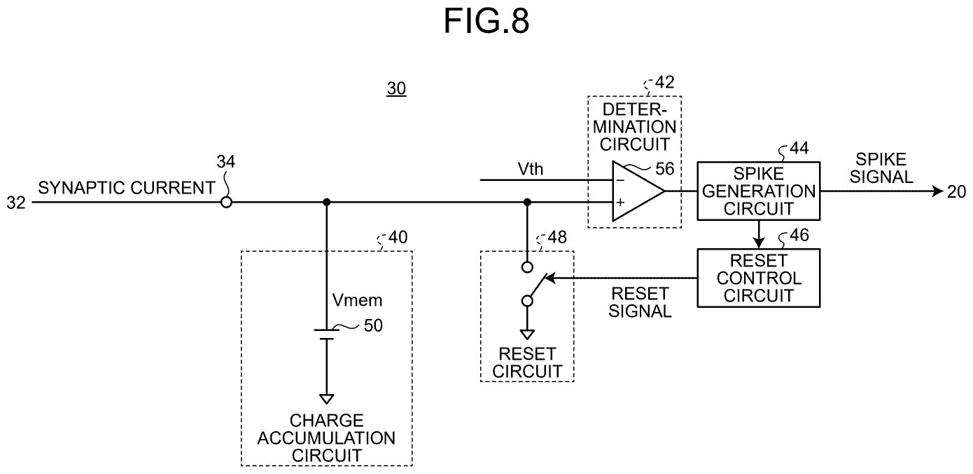

FIG. 8 is a diagram illustrating a configuration of a first neuron circuit 30 according to the third embodiment.

The charge accumulation circuit 40 according to the third embodiment does not include the leakage circuit 52 as compared with the first embodiment. Therefore, in the secondary battery element 50 according to the third embodiment, there is no charge release or fall of the membrane potential Vₘₑₘ in a period other than the refractory period. There is also a neuron firing model having no consideration of a decrease in the membrane potential Vₘₑₘ due to leakage. The first neuron circuit 30 according to the third embodiment can achieve such a model having no consideration of the fall of the membrane potential Vₘₑₘ due to leakage.

### Fourth Embodiment

Hereinafter, a neural network device 10 according to a fourth embodiment will be described.

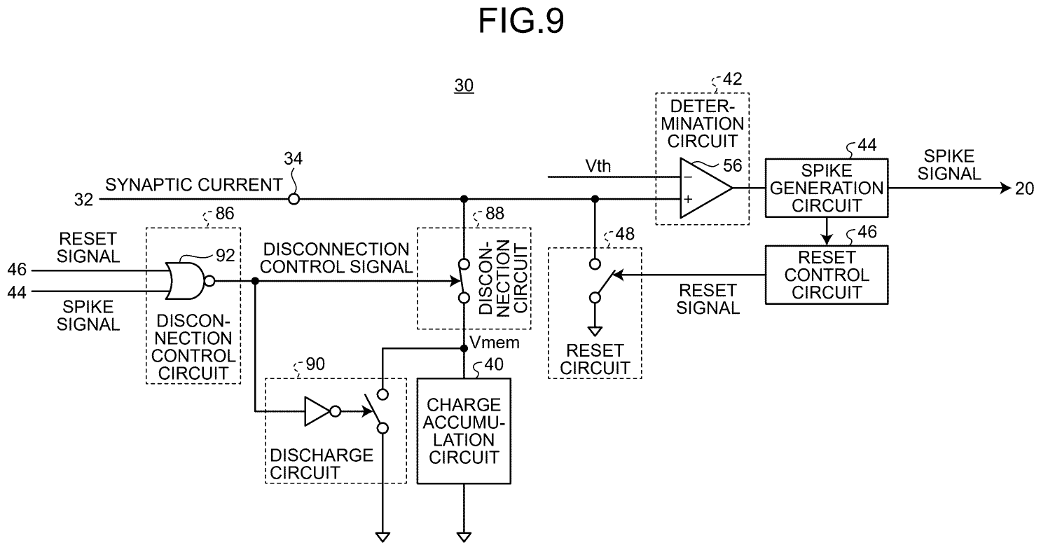

FIG. 9 is a diagram illustrating a configuration of a first neuron circuit 30 according to the fourth embodiment.

The first neuron circuit 30 according to the fourth embodiment further includes a disconnection control circuit 86, a disconnection circuit 88, and a discharge circuit 90.

The disconnection control circuit 86 stops the accumulation of charges according to the synaptic current supplied to the first terminal 34 by the secondary battery element 50 during a period in which the spike signal is generated from the spike generation circuit 44 and during the refractory period. For example, the disconnection control circuit 86 disconnects the secondary battery element 50 from the first terminal 34 during the period in which the spike signal is generated from the spike generation circuit 44 and during the refractory period.

In the present embodiment, the disconnection control circuit 86 may be a NOR logic circuit 92. The NOR logic circuit 92 acquires the spike signal from the spike generation circuit 44 and acquires the reset signal from the reset control circuit 46. Subsequently, the NOR logic circuit 92 outputs a disconnection control signal that indicates logical H when the spike signal is at logical H or when the reset signal is at logical H, and that indicates logical H when the spike signal is at logical L and the reset signal is at logical L.

The disconnection circuit 88 disconnects between the first terminal 34 and the secondary battery element 50 during the period in which the spike signal is generated from the spike generation circuit 44 and during the refractory period. In addition, the disconnection circuit 88 short-circuits between the first terminal 34 and the secondary battery element 50 during a period other than the period in which the spike signal is generated from the spike generation circuit 44 and other than the refractory period. For example, the disconnection circuit 88 disconnects between the first terminal 34 and the secondary battery element 50 when the disconnection control signal is at logical L, and short-circuits between the first terminal 34 and the secondary battery element 50 when the disconnection control signal is at logical H. For example, the disconnection circuit 88 may be implemented by a MOSFET or the like that functions as a switch that is turned on or off by a disconnection control signal.

The refractory period is a predetermined time after the end of the occurrence of the spike signal. Therefore, the reset circuit 48 does not connect the first terminal 34 to the ground terminal during the period in which the spike signal is generated, namely, during the period in which the spike signal is at logical H. Therefore, in the first embodiment, in a case where a synaptic current is supplied during a period in which a spike signal is generated, charges are undesirably accumulated in the secondary battery element 50.

In contrast, in the present embodiment, the secondary battery element 50 is disconnected from the first terminal 34 during the period in which the spike signal is generated. This makes it possible for the disconnection control circuit 86 and the disconnection circuit 88 to prevent charges from being accumulated in the secondary battery element 50 even when a synaptic current is supplied during the period in which the spike signal is generated. This enables the disconnection control circuit 86 and the disconnection circuit 88 to shorten the discharge time of the secondary battery element 50.

The discharge circuit 90 discharges the charge accumulated in the secondary battery element 50 during the period in which the spike signal is generated from the spike generation circuit 44 and during the refractory period. For example, when the disconnection control signal is at logical H, the discharge circuit 90 connects a terminal of the secondary battery element 50 which is not connected to the ground terminal, to the ground terminal. When the disconnection control signal is at logical L, the discharge circuit 90 disconnects the terminal of the secondary battery element 50 which is not connected to the ground terminal, from the ground terminal. The discharge circuit 90 may be implemented by an inverter circuit that inverts the logic of the disconnection control signal and a device such as a MOSFET that functions as a switch that is turned on or off by an output signal of the inverter circuit.

The discharge circuit 90 may use the reset signal to switch whether to discharge the charge accumulated in the secondary battery element 50. For example, when the reset signal is at logical H, the discharge circuit 90 may connect a terminal of the secondary battery element 50 which is not connected to the ground terminal, to the ground terminal. In addition, when the reset signal is at logical L, the discharge circuit 90 may disconnect the terminal of the secondary battery element 50 which is not connected to the ground terminal, from the ground terminal.

The discharge circuit 90 like this can discharge the charge accumulated in the secondary battery element 50 during the period in which the spike signal is generated from the spike generation circuit 44. This makes it possible for the discharge circuit 90 to release the charge accumulated in the secondary battery element 50 before the refractory period, leading to reduction of the discharge time.

In the fourth embodiment, the charge accumulation circuit 40 may include the electronic/ionic resistive element 72 similarly to the second embodiment, or may omit the resistive element 54 similarly to the third embodiment.

### Fifth Embodiment

Hereinafter, a neural network device 10 according to a fifth embodiment will be described.

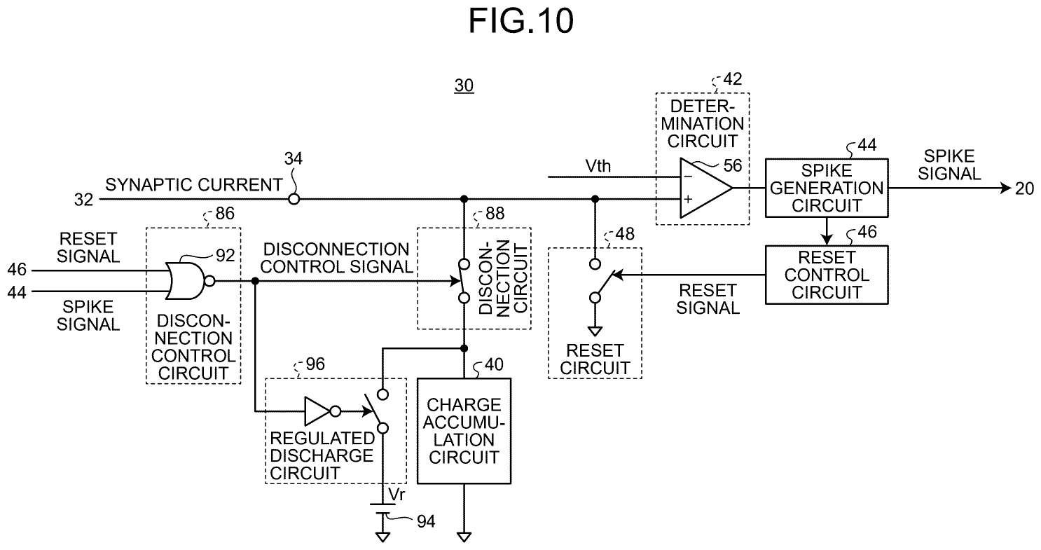

FIG. 10 is a diagram illustrating a configuration of a first neuron circuit 30 according to the fifth embodiment.

The charge accumulation circuit 40 according to the fifth embodiment further includes a disconnection control circuit 86, a disconnection circuit 88, a reset potential generation circuit 94, and a regulated discharge circuit 96.

The disconnection control circuit 86 and the disconnection circuit 88 according to the fifth embodiment have the same configurations as those of the fourth embodiment.

The reset potential generation circuit 94 generates a predetermined reset potential Vᵣ. For example, the reset potential generation circuit 94 may be a constant voltage circuit that generates the reset potential Vᵣ. The reset potential Vᵣ is a voltage that is lower than the threshold potential Vₜₕ and higher than the potential of the ground terminal.

The regulated discharge circuit 96 discharges the charge accumulated in the secondary battery element 50 during the period in which the spike signal is generated from the spike generation circuit 44 and during the refractory period. Together with this, the regulated discharge circuit 96 stops the discharge of the charge generated from the secondary battery element 50 at a point when the membrane potential Vₘₑₘ reaches the reset potential Vᵣ.

In one example, when the disconnection control signal is at logical H, the regulated discharge circuit 96 connects a terminal of the secondary battery element 50 which is not connected to the ground terminal, to the reset potential Vᵣ. In addition, when the disconnection control signal is at logical L, the regulated discharge circuit 96 disconnects a terminal of the secondary battery element 50 which is not connected to the ground terminal, from the reset potential Vᵣ. For example, the regulated discharge circuit 96 may be implemented by an inverter circuit that inverts the logic of the disconnection control signal and a device such as a MOSFET that functions as a switch that is turned on or off by an output signal of the inverter circuit. The regulated discharge circuit 96 like this can stop the lowering of the membrane potential Vₘₑₘ during the period in which the spike signal is generated and during the refractory period, at the reset potential Vᵣ.

The frequency of firing of neurons is determined based on the potential difference between the threshold potential Vₜₕ and the initial potential and based on the total current amount per unit time given by the synapse. Therefore, the initial potential does not need to be the potential of the ground terminal as long as the initial potential is a predetermined potential. Therefore, by using the regulated discharge circuit 96 to the initial potential of the membrane potential Vₘₑₘ to the reset potential Vᵣ, the first neuron circuit 30 can perform firing at an appropriate frequency so as to perform an operation mimicking the operation of the brain.

The regulated discharge circuit 96 may use the reset signal to switch whether to discharge the charge accumulated in the secondary battery element 50. For example, when the reset signal is at logical H, the regulated discharge circuit 96 may connect a terminal of the secondary battery element 50 which is not connected to the ground terminal, to the reset potential Vᵣ. In addition, when the reset signal is at logical L, the discharge circuit 90 may disconnect the terminal of the secondary battery element 50 which is not connected to the ground terminal, from the reset potential Vᵣ.

In the fifth embodiment, the disconnection circuit 88 may operate by an inverted signal of a reset signal instead of the disconnection control signal. Thus, in the fifth embodiment, the disconnection circuit 88 may disconnect between the first terminal 34 and the secondary battery element 50 during the refractory period.

Additionally, in the fifth embodiment, the charge accumulation circuit 40 may include the electronic/ionic resistive element 72 similarly to the second embodiment, or may omit the resistive element 54 similarly to the third embodiment.

### Sixth Embodiment

Hereinafter, a neural network device 10 according to a sixth embodiment will be described.

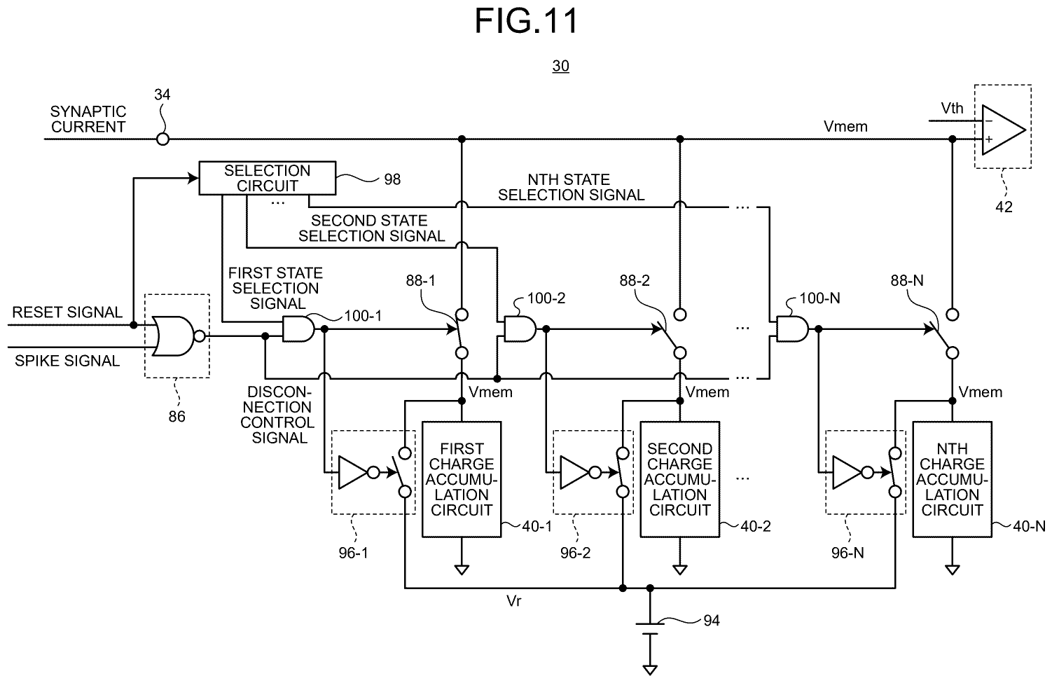

FIG. 11 is a diagram illustrating a configuration of a first neuron circuit 30 according to the sixth embodiment.

The first neuron circuit 30 according to the sixth embodiment includes a determination circuit 42, a spike generation circuit 44, a reset control circuit 46, a reset circuit 48, a disconnection control circuit 86, N charge accumulation circuits 40-1 to 40-N, a selection circuit 98, N logical product circuits 100-1 to 100-N, N disconnection circuits 88-1 to 88-N, a reset potential generation circuit 94, and N regulated discharge circuits 96-1 to 96-N. Note that FIG. 11 omits illustration of the spike generation circuit 44, the reset control circuit 46, and the reset circuit 48.

The disconnection control circuit 86 has a configuration similar to the configuration in the fourth embodiment.

Each of the N charge accumulation circuits 40-1 to 40-N has the same configuration as the charge accumulation circuit 40 according to any of the first to third embodiments.

The selection circuit 98 selects any one of the N states from the first state to the N-th state.

The first state is a state in which the potential generated from the secondary battery element 50 included in the first charge accumulation circuit 40-1 among the N charge accumulation circuits 40-1 to 40-N is to be output as the membrane potential Vₘₑₘ, and the synaptic current supplied to the first terminal 34 is to be accumulated in the secondary battery element 50 included in the first charge accumulation circuit 40-1. Moreover, the first state is a state to release the charge accumulated in the secondary battery element 50 included in the charge accumulation circuit 40, other than the first charge accumulation circuit 40-1 among the N charge accumulation circuits 40-1 to 40-N.

The second state is a state in which the potential generated from the secondary battery element 50 included in the second charge accumulation circuit 40-2 different from the first charge accumulation circuit 40-1, among the N charge accumulation circuits 40-1 to 40-N, is output as the membrane potential Vₘₑₘ, and the synaptic current supplied to the first terminal 34 is accumulated in the secondary battery element 50 included in the second charge accumulation circuit 40-2. Moreover, the second state is a state to release the charge accumulated in the secondary battery element 50 included in the charge accumulation circuit 40, other than the second charge accumulation circuit 40-2 among the N charge accumulation circuits 40-1 to 40-N.

Specifically, the n-th state (n is an integer of 1 or more and N or less) among the N states is a state in which the potential generated from the secondary battery element 50 included in the n-th charge accumulation circuit 40-n is output as the membrane potential Vₘₑₘ, and the synaptic current supplied to the first terminal 34 is accumulated in the secondary battery element 50 included in the n-th charge accumulation circuit 40-n. Moreover, the n-th state is a state to release the charge accumulated in the secondary battery element 50 included in the charge accumulation circuit 40, other than the n-th charge accumulation circuit 40-n among the N charge accumulation circuits 40-1 to 40-N.

Such a selection circuit 98 outputs N state selection signals. The N state selection signals include a first state selection signal to an N-th state selection signal. When selecting the first state, the selection circuit 98 sets the first state selection signal at logical H and sets the state selection signal other than the first state selection signal among the N state selection signals at logical L. When selecting the second state, the selection circuit 98 sets the second state selection signal at logical H and sets the state selection signal other than the second state selection signal among the N state selection signals at logical L. When selecting the n-th state, the selection circuit 98 sets the n-th state selection signal at logical H and sets the state selection signal other than the n-th state selection signal among the N state selection signals at logical L.

Each of the N logical product circuits 100-1 to 100-N acquires the disconnection control signal output from the disconnection control circuit 86.

The first logical product circuit 100-1 among the N logical product circuits 100-1 to 100-N further acquires the first state selection signal, and outputs a first disconnection control signal representing the logical product of the disconnection control signal and the first state selection signal. The second logical product circuit 100-2 among the N logical product circuits 100-1 to 100-N further acquires the second state selection signal, and outputs a second disconnection control signal representing the logical product of the disconnection control signal and the second state selection signal. The n-th logical product circuit 100-n among the N logical product circuits 100-1 to 100-N further acquires the n-th state selection signal, and outputs an n-th disconnection control signal representing the logical product of the disconnection control signal and the n-th state selection signal.

The first disconnection circuit 88-1 among the N disconnection circuits 88-1 to 88-N short-circuits between the first terminal 34 and the secondary battery element 50 included in the first charge accumulation circuit 40-1 in the first state, and disconnects between the first terminal 34 and the secondary battery element 50 included in the first charge accumulation circuit 40-1 in a state other than the first state among the N states. The second disconnection circuit 88-2 among the N disconnection circuits 88-1 to 88-N short-circuits between the first terminal 34 and the secondary battery element 50 included in the second charge accumulation circuit 40-2 in the second state, and disconnects between the first terminal 34 and the secondary battery element 50 included in the second charge accumulation circuit 40-2 in a state other than the second state among the N states. The n-th disconnection circuit 88-n among the N disconnection circuits 88-1 to 88-N short-circuits between the first terminal 34 and the secondary battery element 50 included in the n-th charge accumulation circuit 40-n in the n-th state, and disconnects between the first terminal 34 and the secondary battery element 50 included in the n-th charge accumulation circuit 40-n in a state other than the n-th state among the N states.

Moreover, each of the N disconnection circuits 88-1 to 88-N disconnects between the first terminal 34 and the secondary battery element 50 included in the corresponding charge accumulation circuit 40 during a period in which the spike signal is generated from the spike generation circuit 44 and during the refractory period.

For example, the first disconnection circuit 88-1 short-circuits between the first terminal 34 and the secondary battery element 50 included in the first charge accumulation circuit 40-1 when the first disconnection control signal output from the first logical product circuit 100-1 is at logical H, and disconnects between the first terminal 34 and the secondary battery element 50 included in the first charge accumulation circuit 40-1 when the first disconnection control signal is at logical L. For example, the second disconnection circuit 88-2 short-circuits between the first terminal 34 and the secondary battery element 50 included in the second charge accumulation circuit 40-2 when the second disconnection control signal output from the second logical product circuit 100-2 is at logical H, and disconnects between the first terminal 34 and the secondary battery element 50 included in the second charge accumulation circuit 40-2 when the second disconnection control signal is at logical L. The n-th disconnection circuit 88-n short-circuits between the first terminal 34 and the secondary battery element 50 included in the n-th charge accumulation circuit 40-n when the n-th disconnection control signal output from the n-th logical product circuit 100 n is at logical H, and disconnects between the first terminal 34 and the secondary battery element 50 included in the n-th charge accumulation circuit 40-n when the n-th disconnection control signal is at logical L.

The reset potential generation circuit 94 has the same configuration as the configuration of the fourth embodiment.

The first regulated discharge circuit 96-1 among the N regulated discharge circuits 96-1 to 96-N releases the charge accumulated in the secondary battery element 50 included in the first charge accumulation circuit 40-1 in a state other than the first state among the N states. Together with this, the first regulated discharge circuit 96-1 stops the discharge of the charges accumulated in the secondary battery element 50 included in the first charge accumulation circuit 40-1 at a point when the membrane potential Vₘₑₘ reaches the reset potential Vᵣ.

The second regulated discharge circuit 96-2 among the N regulated discharge circuits 96-1 to 96-N releases the charge accumulated in the secondary battery element 50 included in the second charge accumulation circuit 40-2 in a state other than the second state among the N states. Together with this, the second regulated discharge circuit 96-2 stops the discharge of the charges accumulated in the secondary battery element 50 included in the second charge accumulation circuit 40-2 at a point when the membrane potential Vₘₑₘ reaches the reset potential Vᵣ.

The n-th regulated discharge circuit 96-n among the N regulated discharge circuits 96-1 to 96-N releases the charge accumulated in the secondary battery element 50 included in the n-th charge accumulation circuit 40-n in a state other than the n-th state among the N states. Together with this, the n-th regulated discharge circuit 96-n stops the discharge of the charges accumulated in the secondary battery element 50 included in the n-th charge accumulation circuit 40-n at a point when the membrane potential Vₘₑₘ reaches the reset potential Vᵣ.

Moreover, each of the N regulated discharge circuits 96-1 to 96-N releases the charge accumulated in the secondary battery element 50 included in the corresponding charge accumulation circuit 40 during the period in which the spike signal is generated from the spike generation circuit 44 and during the refractory period.

In one example, when the first disconnection control signal is at logical L, the first regulated discharge circuit 96-1 connects a terminal not connected to the ground terminal in the secondary battery element 50 included in the first charge accumulation circuit 40-1, to the reset potential Vᵣ. When the first disconnection control signal is at logical L, the first regulated discharge circuit 96-1 disconnects the terminal not connected to the ground terminal in the secondary battery element 50 included in the first charge accumulation circuit 40-1, from the reset potential Vᵣ.

In one example, when the second disconnection control signal is at logical L, the second regulated discharge circuit 96-2 connects the terminal not connected to the ground terminal in the secondary battery element 50 included in the second charge accumulation circuit 40-2, to the reset potential Vᵣ. When the second disconnection control signal is at logical L, the second regulated discharge circuit 96-2 disconnects the terminal not connected to the ground terminal in the secondary battery element 50 included in the second charge accumulation circuit 40-2, from the reset potential Vᵣ.

In one example, when the n-th disconnection control signal is at logical L, the n-th regulated discharge circuit 96-n connects the terminal not connected to the ground terminal in the secondary battery element 50 included in the n-th charge accumulation circuit 40-n, to the reset potential Vᵣ. When the n-th disconnection control signal is at logical L, the n-th regulated discharge circuit 96-n disconnects the terminal not connected to the ground terminal in the secondary battery element 50 included in the n-th charge accumulation circuit 40-n, from the reset potential Vᵣ.

In the above configuration, the selection circuit 98 cyclically switches one of the first state to the N-th state. For example, during the refractory period after the spike signal is generated in the first state, the selection circuit 98 switches the state to the second state. Moreover, during the refractory period after the spike signal is generated in the second state, the selection circuit 98 switches the state to the third state.

Moreover, during the refractory period after the spike signal is generated in the n-th state, the selection circuit 98 switches the state to the (n+1) state. Here, n+1 is N or less. In addition, during the refractory period after the spike signal is generated in the n-th state, the selection circuit 98 switches the state to the first state.

The first neuron circuit 30 according to the sixth embodiment having such a configuration sequentially selects N charge accumulation circuits 40-1 to 40-N one by one, and generates the membrane potential Vₘₑₘ in the selected charge accumulation circuit 40. With this configuration, the first neuron circuit 30 according to the sixth embodiment can discharge each of the unselected (N−1) charge accumulation circuits 40 among the N charge accumulation circuits 40-1 to 40-N over a long period of time. Accordingly, even in a case where the capacity of the secondary battery element 50 is large, the first neuron circuit 30 can reliably lower the membrane potential Vₘₑₘ generated from the secondary battery element 50 to the reset potential Vᵣ and then start accumulation of charges according to the synaptic current. With this configuration, with the neural network device 10 according to the sixth embodiment, it is possible to perform an operation that mimics the operation of the brain.

In the sixth embodiment, the n-th regulated discharge circuit 96-n may operate by a reset signal instead of the n-th disconnection control signal. Thus, in the sixth embodiment, the n-th regulated discharge circuit 96-n may release the charge accumulated in the secondary battery element 50 included in the n-th charge accumulation circuit 40-n during the refractory period, and stop the release of the charge generated from the secondary battery element 50 at a point when the membrane potential Vₘₑₘ reaches the reset potential Vᵣ.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplement

The above embodiment can be summarized in the following technical schemes.

### (Technical Scheme 1)

A neural network device comprising:
a plurality of synapse circuits, each of the synapse circuits being assigned with a synaptic weight; and
a plurality of neuron circuits, each of the neuron circuits being configured to generate a spike signal, wherein
each of the synapse circuits is configured to
   acquire the spike signal from one of the neuron circuits, and
   output a synaptic current according to the synaptic weight in response to acquiring the spike signal,
a first neuron circuit in the neuron circuits includes a first terminal, the first terminal being supplied with the synaptic current from each of one or more of the synapse circuits, and
the first neuron circuit includes:
   a secondary battery element configured to accumulate a charge according to the synaptic current supplied to the first terminal;
   a spike generation circuit configured to generate the spike signal when a membrane potential generated from the secondary battery element is larger than a threshold potential being a predetermined potential; and
   a reset control circuit configured to release the charge accumulated in the secondary battery element during a refractory period being a predetermined time period after generation of the spike signal.

### (Technical Scheme 2)

The neural network device according to the technical scheme 1, wherein the secondary battery element includes:
a first solid electrolyte layer with a solid electrolyte having ion permeability and having less electron permeability;
a first electrode layer and a second electrode layer provided to face each other across the first solid electrolyte layer, the first electrode layer and the second electrode layer each being a solid substance capable of containing the ions in a lattice gap or a lattice position;
a first current collector layer with metal, the first current collector layer being connected to the first electrode layer; and
a second current collector layer with metal, the first current collector layer being connected to the second electrode layer.

### (Technical Scheme 3)

The neural network device according to the technical scheme 2, wherein
the first current collector layer is connected to the first terminal, and
the second current collector layer is connected to a ground terminal.

### (Technical Scheme 4)

The neural network device according to the technical scheme 2 or 3, wherein the ion is a lithium ion.

### (Technical Scheme 5)

The neural network device according to any one of the technical schemes 1 to 4, further comprising a leakage circuit configured to leak the charges accumulated in the secondary battery element.

### (Technical Scheme 6)

The neural network device according to the technical scheme 5, wherein the leakage circuit includes a resistive element connected between the first terminal and a ground terminal.

### (Technical Scheme 7)

The neural network device according to the technical scheme 5 or 6, wherein
the leakage circuit includes an electronic/ionic resistive element,
the electronic/ionic resistive element includes:
   a second solid electrolyte layer with a solid electrolyte having ion permeability and having less electron permeability;
   a third electrode layer and a fourth electrode layer provided to face each other across the second solid electrolyte layer, the third electrode layer and the fourth electrode layer each being solid substance capable of containing the ions in a lattice gap or a lattice position;
   a third current collector layer with metal, the third current collector layer being connected to the third electrode layer; and
   a fourth current collector layer with metal, the fourth current collector layer being connected to the fourth electrode layer,
the third electrode layer and the fourth electrode layer include an identical substance,
the third current collector layer is connected to the first terminal, and
the fourth current collector layer is connected to a ground terminal.

### (Technical Scheme 8)

The neural network device according to any one of the technical schemes 1 to 7, wherein the first neuron circuit further includes a disconnection control circuit configured to stop the accumulation of the charge according to the synaptic current supplied to the first terminal by the secondary battery element during a period in which the spike signal is generated and during the refractory period.

### (Technical Scheme 9)

The neural network device according to any one of the technical schemes 1 to 8, wherein the first neuron circuit further includes a regulated discharge circuit configured to stop release of the charge generated from the secondary battery element, at a point when the membrane potential reaches a predetermined reset potential.

### (Technical Scheme 10)

A neural network device comprising:
a plurality of neuron circuits, each of the neuron circuits being configured to generate a spike signal; and
a plurality of synapse circuits, each of the synapse circuits being assigned with a synaptic weight, wherein
each of the synapse circuits is configured to
   acquire the spike signal from one of the neuron circuits, and
   output a synaptic current according to the synaptic weight in response to acquiring the spike signal,
a first neuron circuit in the neuron circuits includes a first terminal, the first terminal being supplied with the synaptic current from each of one or more of the synapse circuits,
the first neuron circuit includes:
   N charge accumulation circuits (N is an integer of 2 or more), each including a secondary battery element configured to accumulate a charge according to the synaptic current and supplied to the first terminal;
   a spike generation circuit configured to generate the spike signal when a membrane potential generated from one of the N charge accumulation circuits is larger than a threshold potential being a predetermined potential;
   a reset control circuit configured to release the charge accumulated in the N charge accumulation circuits during a refractory period being a predetermined time after generation of the spike signal; and
   a selection circuit configured to select one of N states,
a first state among the N states is a state where
   a potential generated from the secondary battery element included in a first charge accumulation circuit among the N charge accumulation circuits is to be output as the membrane potential,
   the synaptic current supplied to the first terminal is to be accumulated in the secondary battery element included in the first charge accumulation circuit, and
   the charge accumulated in the secondary battery element included in a charge accumulation circuit other than the first charge accumulation circuit among the N charge accumulation circuits is to be released,
a second state among the N states is a state where
   a potential generated from the secondary battery element included in a second charge accumulation circuit different from the first charge accumulation circuit among the N charge accumulation circuits is to be output as the membrane potential,
   the synaptic current supplied to the first terminal is to be accumulated in the secondary battery element included in the second charge accumulation circuit, and
   the charge accumulated in the secondary battery element included in a charge accumulation circuit other than the second charge accumulation circuit among the N charge accumulation circuits is to be released, and
the selection circuit is configured to switch to the second state after the spike signal is generated in the first state.

### (Technical Scheme 11)

The neural network device according to the technical scheme 10, wherein the selection circuit is configured to switch from the first state to the second state in the refractory period.

### (Technical Scheme 12)

The neural network device according to the technical scheme 11, wherein the first neuron circuit further includes a regulated discharge circuit configured to stop release of the charges generated from the secondary battery element included in each of the N charge accumulation circuits, at a point when the membrane potential reaches a predetermined reset potential.

### (Technical Scheme 13)

The neural network device according to any one of the technical schemes 10 to 12, wherein the first neuron circuit further includes a disconnection control circuit configured to disconnect the secondary battery element from the first terminal during the period in which the spike signal is generated and during the refractory period.

### (Technical Scheme 14)

A membrane potential holding method implemented by a neural network device, the neural network device including a plurality of synapse circuits and a plurality of neuron circuits, each of the synapse circuits being assigned with a synaptic weight, each of the neuron circuits generating a spike signal, the method comprising:
in each of the synapse circuits,
   acquiring the spike signal from one of the neuron circuits, and
   outputting a synaptic current according to the synaptic weight in response to acquiring the spike signal,
supplying the synaptic current from each of one or more first synapse circuits in the synapse circuits to a first terminal in a first neuron circuit in the neuron circuits;
accumulating, in a secondary battery element, a charge according to the synaptic current to be supplied to the first terminal;
generating the spike signal when a membrane potential generated from the secondary battery element is larger than a threshold potential being a predetermined potential; and
releasing the charge accumulated in the secondary battery element during a refractory period being a predetermined time period after generation of the spike signal.

What is claimed is:

1. A neural network device comprising:
a plurality of synapse circuits, each of the synapse circuits being assigned with a synaptic weight; and
a plurality of neuron circuits, each of the neuron circuits being configured to generate a spike signal, wherein
each of the synapse circuits is configured to
acquire the spike signal from one of the neuron circuits, and
output a synaptic current according to the synaptic weight in response to acquiring the spike signal,
a first neuron circuit in the neuron circuits includes a first terminal, the first terminal being supplied with the synaptic current from each of one or more of the synapse circuits, and
the first neuron circuit includes:
a secondary battery element configured to accumulate a charge according to the synaptic current supplied to the first terminal;
a spike generation circuit configured to generate the spike signal when a membrane potential generated from the secondary battery element is larger than a threshold potential being a predetermined potential; and
a reset control circuit configured to release the charge accumulated in the secondary battery element during a refractory period being a predetermined time period after generation of the spike signal.

2. The neural network device according to claim 1, wherein the secondary battery element includes:
a first solid electrolyte layer with a solid electrolyte having ion permeability and having less electron permeability;
a first electrode layer and a second electrode layer provided to face each other across the first solid electrolyte layer, the first electrode layer and the second electrode layer each being a solid substance capable of containing the ions in a lattice gap or a lattice position;
a first current collector layer with metal, the first current collector layer being connected to the first electrode layer; and
a second current collector layer with metal, the first current collector layer being connected to the second electrode layer.

3. The neural network device according to claim 2, wherein
the first current collector layer is connected to the first terminal, and
the second current collector layer is connected to a ground terminal.

4. The neural network device according to claim 2, wherein the ion is a lithium ion.

5. The neural network device according to claim 1, further comprising a leakage circuit configured to leak the charges accumulated in the secondary battery element.

6. The neural network device according to claim 5, wherein the leakage circuit includes a resistive element connected between the first terminal and a ground terminal.

7. The neural network device according to claim 5, wherein
the leakage circuit includes an electronic/ionic resistive element,
the electronic/ionic resistive element includes:
a second solid electrolyte layer with a solid electrolyte having ion permeability and having less electron permeability;
a third electrode layer and a fourth electrode layer provided to face each other across the second solid electrolyte layer, the third electrode layer and the fourth electrode layer each being solid substance capable of containing the ions in a lattice gap or a lattice position;
a third current collector layer with metal, the third current collector layer being connected to the third electrode layer; and
a fourth current collector layer with metal, the fourth current collector layer being connected to the fourth electrode layer,
the third electrode layer and the fourth electrode layer include an identical substance,
the third current collector layer is connected to the first terminal, and
the fourth current collector layer is connected to a ground terminal.

8. The neural network device according to claim 1, wherein the first neuron circuit further includes a disconnection control circuit configured to stop the accumulation of the charge according to the synaptic current supplied to the first terminal by the secondary battery element during a period in which the spike signal is generated and during the refractory period.

9. The neural network device according to claim 1, wherein the first neuron circuit further includes a regulated discharge circuit configured to stop release of the charge generated from the secondary battery element, at a point when the membrane potential reaches a predetermined reset potential.

10. A neural network device comprising:
a plurality of neuron circuits, each of the neuron circuits being configured to generate a spike signal; and
a plurality of synapse circuits, each of the synapse circuits being assigned with a synaptic weight, wherein
each of the synapse circuits is configured to
acquire the spike signal from one of the neuron circuits, and
output a synaptic current according to the synaptic weight in response to acquiring the spike signal,
a first neuron circuit in the neuron circuits includes a first terminal, the first terminal being supplied with the synaptic current from each of one or more of the synapse circuits,
the first neuron circuit includes:
N charge accumulation circuits (N is an integer of 2 or more), each including a secondary battery element configured to accumulate a charge according to the synaptic current and supplied to the first terminal;
a spike generation circuit configured to generate the spike signal when a membrane potential generated from one of the N charge accumulation circuits is larger than a threshold potential being a predetermined potential;
a reset control circuit configured to release the charge accumulated in the N charge accumulation circuits during a refractory period being a predetermined time after generation of the spike signal; and
a selection circuit configured to select one of N states,
a first state among the N states is a state where
a potential generated from the secondary battery element included in a first charge accumulation circuit among the N charge accumulation circuits is to be output as the membrane potential,
the synaptic current supplied to the first terminal is to be accumulated in the secondary battery element included in the first charge accumulation circuit, and
the charge accumulated in the secondary battery element included in a charge accumulation circuit other than the first charge accumulation circuit among the N charge accumulation circuits is to be released,
a second state among the N states is a state where
a potential generated from the secondary battery element included in a second charge accumulation circuit different from the first charge accumulation circuit among the N charge accumulation circuits is to be output as the membrane potential,
the synaptic current supplied to the first terminal is to be accumulated in the secondary battery element included in the second charge accumulation circuit, and
the charge accumulated in the secondary battery element included in a charge accumulation circuit other than the second charge accumulation circuit among the N charge accumulation circuits is to be released, and
the selection circuit is configured to switch to the second state after the spike signal is generated in the first state.

11. The neural network device according to claim 10, wherein the selection circuit is configured to switch from the first state to the second state in the refractory period.

12. The neural network device according to claim 11, wherein the first neuron circuit further includes a regulated discharge circuit configured to stop release of the charges generated from the secondary battery element included in each of the N charge accumulation circuits, at a point when the membrane potential reaches a predetermined reset potential.

13. The neural network device according to claim 10, wherein the first neuron circuit further includes a disconnection control circuit configured to disconnect the secondary battery element from the first terminal during the period in which the spike signal is generated and during the refractory period.

14. A membrane potential holding method implemented by a neural network device, the neural network device including a plurality of synapse circuits and a plurality of neuron circuits, each of the synapse circuits being assigned with a synaptic weight, each of the neuron circuits generating a spike signal, the method comprising:
in each of the synapse circuits,
acquiring the spike signal from one of the neuron circuits, and
outputting a synaptic current according to the synaptic weight in response to acquiring the spike signal,
supplying the synaptic current from each of one or more first synapse circuits in the synapse circuits to a first terminal in a first neuron circuit in the neuron circuits;
accumulating, in a secondary battery element, a charge according to the synaptic current to be supplied to the first terminal;
generating the spike signal when a membrane potential generated from the secondary battery element is larger than a threshold potential being a predetermined potential; and
releasing the charge accumulated in the secondary battery element during a refractory period being a predetermined time period after generation of the spike signal.
